(19) United States
(12) Patent Application Publication
(10) Pub. No.: US 2012/0313616 A1
(43) Pub. Date: Dec. 13, 2012

(54) AC DISCHARGE CIRCUIT FOR AN AC-TO-DC SWITCHING POWER CONVERTER

(76) Inventors: Yi-Wei Lee, Taipei City (TW); Chih-Feng Huang, Hsinchu County (TW)

(21) Appl. No.: 13/487,049

(22) Filed: Jun. 1, 2012

(30) Foreign Application Priority Data
Jun. 8, 2011 (TW) 100119989

(51) Int. Cl. G05F 3/04

(52) U.S. Cl. 323/312

(57) ABSTRACT

An AC discharge circuit is disclosed to eliminate the need of bleeding resistors for an AC-to-DC switching power converter. The AC-to-DC switching power converter has two AC power input terminals to be connected to an AC power source, and an AC input capacitor connected between the two AC power input terminals. The AC discharge circuit has a rectifier circuit to rectify a first voltage across the AC input capacitor to be a second voltage applied to an input terminal of a JFET, and a power removal detector to monitor a third voltage at an output terminal of the JFET to trigger a power removal signal to discharge the AC input capacitor when the third voltage has been remained larger than a threshold for a de-bounce time.

### FIELD OF THE INVENTION

The present invention is related generally to an AC-to-DC switching power converter and, more particularly, to an AC discharge circuit for an AC-to-DC switching power converter.

### BACKGROUND OF THE INVENTION

As shown in FIG. 1, an AC-to-DC switching power converter has AC power input terminals 10 and 12 to be connected to an AC power source, an AC input capacitor CX1 connected between the AC power input terminals 10 and 12 for filtering out high-frequency signals, and a controller 14 for providing a control signal Vg to switch a power switch Q1 to offer energy through a transformer T1 to a load capacitor CL, thereby generating a DC output voltage Vo. When the AC power source connected to AC power input terminals 10 and 12 is removed, the AC input capacitor CX1 will remain a DC voltage equal to the voltage provided by the AC power source at the instant moment of removing the AC power source, which may imperil people therearound with the risk of electric shocks. Conventionally, to eliminate the risk, bleeding resistors R1 and R2 that are connected in series to each other are shunt to the AC input capacitor CX1 to reduce the residue voltage of the AC input capacitor CX1 to a safe range within a specified period after the AC power source is removed. However, the bleeding resistors R1 and R2 always cause additional power loss P_loss=(Vin_rms)²/(R1+R2), where Vin_rms is the root-mean-square value of the voltage provided by the AC power source. When an AC-to-DC switching power converter enters no-load or standby mode, the power loss caused by the bleeding resistors R1 and R2 is even more serious, making the AC-to-DC switching power converter hard to meet the latest green energy requirements.

### SUMMARY OF THE INVENTION

An objective of the present invention is to eliminate the need of bleeding resistors for an AC-to-DC switching power converter.

Another objective of the present invention is to provide an AC discharge circuit for an AC-to-DC switching power converter.

Still another objective of the present invention is to provide a simple structure for the bleeding circuit at the AC input terminals of an AC-to-DC switching power converter.

According to the present invention, an AC-to-DC switching power converter has two AC power input terminals to be connected to an AC power source, and an AC input capacitor connected between the two AC power input terminals, and an AC discharge circuit has a rectifier circuit to rectify a first voltage across the AC input capacitor to be a second voltage applied to an input terminal of a JFET, and a power removal detector to monitor a third voltage at an output terminal of the JFET to trigger a power removal signal to discharge the AC input capacitor when the third voltage has been remained larger than a threshold for a de-bounce time.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a circuit diagram of a conventional AC-to-DC switching power converter;

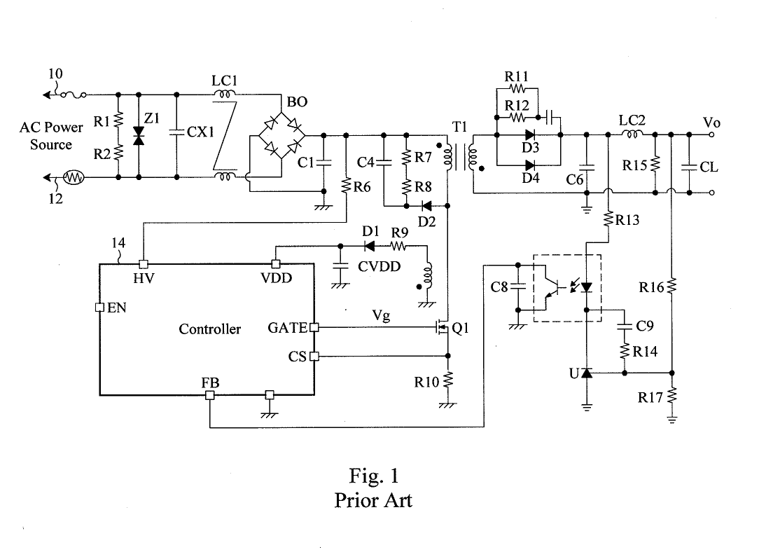

FIG. 2 is an AC discharge circuit according to the present invention; and

FIG. 3 is a waveform diagram of the circuit shown in FIG. 2.

### DETAILED DESCRIPTION OF THE INVENTION

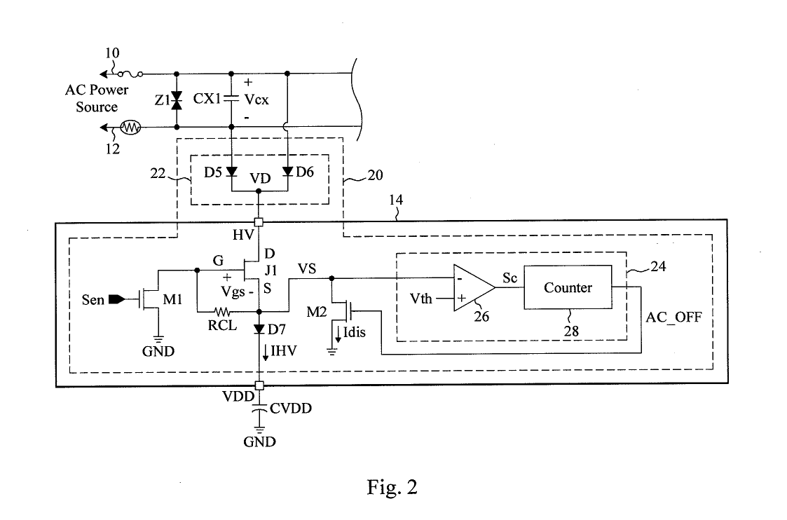

According to the present invention, as shown in FIG. 2, an AC discharge circuit 20 for an AC-to-DC switching power converter includes a rectifier circuit 22 connected to two terminals of an AC input capacitor CX1 for rectifying the across voltage Vcx of the AC input capacitor CX1 to be a voltage VD, a junction field effect transistor (JFET) J1 having an input terminal D connected to the rectifier circuit 22 through a pin HV of the controller 14 to receive the voltage VD, a current limit resistor RCL connected between a control terminal G and an output terminal S of the JFET J1, a switch M1 connected between the control terminal G of the JFET J1 and a ground terminal GND and controlled by a signal Sen, a forward diode D7 having an anode connected to the output terminal S of the JFET J1 and a cathode connected to a power source capacitor CVDD through a pin VDD of the controller 14 for preventing reverse current which otherwise flows from the power source capacitor CVDD to the output terminal S of the JFET J1, a power removal detector 24 monitoring the voltage VS at the output terminal S of the JFET J1 for detecting removal of the AC power source from the AC power input terminals 10 and 12 to trigger a power removal signal AC_OFF, and a switch M2 connected between the output terminal S of the JFET J1 and a ground terminal GND for conducting a discharging current Idis responsive to the power removal signal AC_OFF to release the charges on the AC input capacitor CX1 through the rectifier circuit 22, the JFET J1 and the switch M2 to the ground terminal GND, thereby reducing the across voltage Vcx of the AC input capacitor CX1 to a safe range within a specified time period. The power removal detector 24 includes a comparator 26 and a counter 28. The comparator 26 compares the voltage VS to a threshold Vth to assert a comparison signal Sc, which is high when the voltage VS is lower than the threshold Vth. If the counter 28 has not received a high-level comparison signal Sc for a de-bounce time T1, it will trigger the power removal signal AC_OFF. The de-bounce time T1 is set for preventing the counter 28 from mis-operation activated by any undesired trigger signal or by noise of the AC power source.

The AC discharge circuit 20 shown in FIG. 2 may act as a high-voltage startup circuit for the AC-to-DC switching power converter. When the AC power source is connected to the AC power input terminals 10 and 12 of the AC-to-DC switching power converter, the signal Sen will turn on the switch M1 so that the control terminal G of the JFET J1 is grounded. At this time, the voltages at the control terminal G and the output terminal S of the JFET J1 are equal to each other. Since the JFET J1 is a negative threshold voltage device, it will be turned on and generate a current IHV to charge the power source capacitor CVDD. When the voltage VDD at the power source capacitor CVDD rises to a startup level, the AC-to-DC switching power converter completes its startup procedure.

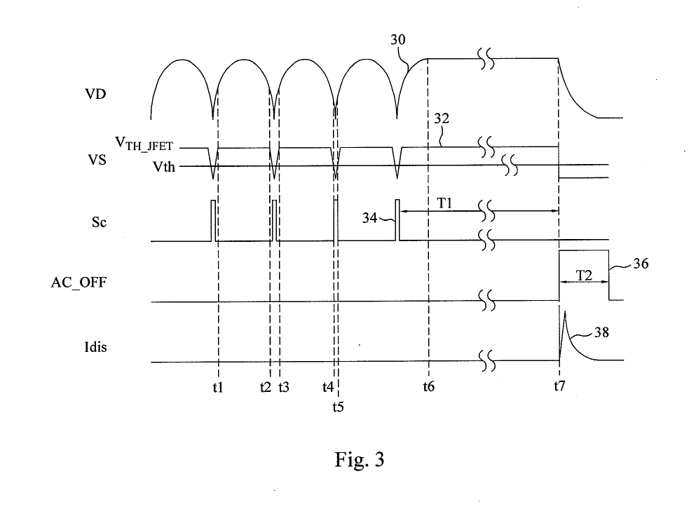

FIG. 3 is a waveform diagram of the circuit shown in FIG. 2, in which waveform 30 represents the voltage VD, waveform 32 represents the voltage VS, waveform 34 represents the comparison signal Sc, waveform 36 represents the power removal signal AC_OFF, and waveform 38 represents the current Idis. After startup of the AC-to-DC switching power converter shown in FIG. 2, the switch M1 remains on, and thus the voltage at the control terminal of the JFET J1 is OV. Assuming that the threshold voltage of the JFET J1 is -VTH_JFET, referring to the waveforms 30 and 32 shown in FIG. 3, when the voltage VD is large enough to make the voltage VS reach VTH_JFET, as shown by time t1 to time t2, the differential voltage Vgs between the control terminal G and the output terminal S of the JFET J1 is equal to the threshold voltage -VTH_JFET, and thus the JFET J1 is off, so that the input terminal D of the JFET J1 will provide a small leakage current to maintain the voltage VS=VTH_JFET. When the voltage VD is not enough to make the voltage VS reach VTH_JFET, the JFET J1 is on, so that the voltage VS is almost equal to the voltage VD, as shown by time t2 to time t3, and thus, when the voltage VD is close to its valley, the voltage VS is almost OV. As illustrated by this embodiment, using the physical characteristic of the JFET J1 can identify the waveform of the voltage VD.

Referring to FIGS. 2 and 3, a threshold Vth close to OV is set. When the comparator 26 in the power removal detector 24 detects that the voltage VS is lower than the threshold Vth, as shown by the waveforms 32 and 34 between time t4 to time t5, it asserts the comparison signal Sc to reset the counter 28 for its count time. When the AC power source is removed, the voltage VD will stay at the level where it is at the moment when the AC power source is removed, as shown by the waveform 30 at time t6. If this voltage VD makes the voltage VS larger than the threshold Vth, the comparison signal Sc will be low and will not reset the counter 28, and when the count time of the counter 28 reaches the de-bounce time T1, the AC discharge circuit 20 identifies removal of the AC power source, and the counter 28 triggers the power removal signal AC_OFF to turn on the switch M2 for a time interval T2, as shown by the waveform 36 at time t7. During the time interval T2, the voltage VS at the output terminal S of the JFET J1 is pulled down to OV, and thus the differential voltage Vgs between the control terminal G and the output terminal S of the JFET J1 will be larger than the threshold voltage -VTH_JFET, thereby turning on the JFET J1 to generate a discharging current Idis, as shown by the waveform 38. As a result, the charges on the AC input capacitor CX1 is released through the rectifier circuit 22, the JFET J1 and the switch M2 to the ground GND.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An AC discharge circuit for an AC-to-DC switching power converter including two AC power input terminals to be connected to an AC power source, and an AC input capacitor connected between the two AC power input terminals, the AC discharge circuit comprising:
a rectifier circuit connected to two terminals of the AC input capacitor, rectifying a first voltage across the AC input capacitor to be a second voltage;
a JFET having a control terminal, an output terminal and an input terminal, the input terminal being connected to the rectifier circuit to receive the second voltage; and
a power removal detector connected to the output terminal of the JFET, monitoring a third voltage at the output terminal of the JFET to trigger a power removal signal when the third voltage remains higher than a threshold for a de-bounce time, to discharge the AC input capacitor.

2. The AC discharge circuit of claim 1, further comprising a switch connected between the output terminal of the JFET and a ground terminal, being turned on responsive to the power removal signal to discharge the AC input capacitor.

3. The AC discharge circuit of claim 1, wherein the power removal detector comprises:
a comparator connected to the output terminal of the JFET, comparing the third voltage to the threshold to assert a comparison signal when the third voltage is smaller than the threshold; and
a counter connected to the comparator, counting for triggering the power removal signal when the comparison signal has not asserted for the de-bounce time.

4. The AC discharge circuit of claim 1, further comprising a diode having an anode connected to the output terminal of the JFET, and a cathode connected to a power source capacitor.
